(19) United States
(12) Patent Application Publication
(10) Pub. No.: US 2014/0125691 A1
(43) Pub. Date: May 8, 2014

(54) ULTRASOUND IMAGING SYSTEM AND METHOD

(71) Applicant: GENERAL ELECTRIC COMPANY, Schenectady, NY (US)

(72) Inventor: Peter Lysyansky, Haifa (IL)

(73) Assignee: GENERAL ELECTRIC COMPANY, Schenectady, NY (US)

(21) Appl. No.: 13/669,169

(22) Filed: Nov. 5, 2012

(51) Int. Cl. G09G 5/00

(52) U.S. Cl. 345/619; 345/672

(57) ABSTRACT

An ultrasound imaging system and method includes receiving a first ultrasound image of a region-of-interest (ROI) and associated first ECG data, the first ultrasound image including an M-mode image or a spectral Doppler image. The system and method includes receiving a cine loop of B-mode images acquired from the ROI and second associated ECG data. The system and method includes selecting a first phase and displaying, at the same time, a first one of the B-mode images at the first phase, the first ultrasound image, and a marker. The marker is positioned at a first position with respect to the first ultrasound image, the first position indicating the first phase.

### FIELD OF THE INVENTION

This disclosure relates generally to an ultrasound imaging system and method for displaying an M-mode image or a spectral Doppler image at the same time as a B-mode image. A marker is displayed with the M-mode image or the spectral Doppler image. The position of the marker with respect to the M-mode image or the spectral Doppler image indicates the phase of the B-mode image.

### BACKGROUND OF THE INVENTION

In echocardiography, there are many tasks and measurements that require identifying an ultrasound image from a very specific portion of the cardiac cycle. For example, it is commonly desired to obtain a volume or other measurement from a specific portion of the cardiac cycle such as aortic valve closure, aortic valve opening, mitral valve closure, or mitral valve opening. According to conventional techniques, a clinician would typically perform a visual assessment of B-mode images that are part of a cine loop in order to manually identify the desired cardiac phase or phases. In terms of workflow, this would most likely involve manually viewing a number of different B-mode images before identifying one of the B-mode images that is close to the desired cardiac phase. Aortic valve closure is defined as the time in the heart cycle when the aortic valves are completely closed and it is typically used to mark the end of ventricular systole. A volume is oftentimes calculated at aortic valve closure in order to calculate an ejection fraction. In healthy patients with normal cardiac function, it may not be too difficult to identify aortic valve closure as long as the B-mode image is from the proper orientation. However, if the patient has an abnormal cardiac cycle or if the imaging plane is not properly located, it can be very difficult to identify the cardiac phase with complete certainty based solely on a B-mode image.

According to conventional techniques, some clinicians and researchers prefer to use spectral Doppler to identify the specific cardiac events that define a particular cardiac phase. For example, using spectral Doppler allows the clinician or researcher to easily see the time in the cardiac cycle when blood ceases to flow from the left ventricle, thus indicating the time of aortic valve closure. Likewise, it is possible to identify other cardiac events by looking for different signatures within the spectral Doppler image. However, this technique poses a problem if the patient's heart rate changes between the acquisition of the ultrasound data used for the measurement and the acquisition of spectral Doppler data. By identifying phase based on spectral Doppler data, the clinician or researcher is only able to identify an absolute time with respect to the spectral Doppler image. However, if the heart rate of the other ultrasound data, such as B-mode data, is different than the heart rate in the spectral Doppler data, the absolute time of the B-mode data will not correspond to the absolute time that was identified in the spectral Doppler data. The difference between the absolute time of the B-mode data and the absolute time of the spectral Doppler data can introduce error into the process of phase determination and this may in turn lead to inaccurate quantitative measurement values.

For these and other reasons an improved method and ultrasound imaging system are desired.

### BRIEF DESCRIPTION OF THE INVENTION

The above-mentioned shortcomings, disadvantages and problems are addressed herein which will be understood by reading and understanding the following specification.

In an embodiment, a method of displaying ultrasound image information using a processor includes receiving a first ultrasound image of a region-of-interest (ROI) and associated first ECG data. The first ultrasound image includes an M-mode image or a spectral Doppler image. The method includes receiving a cine loop of B-mode images acquired from the ROI and associated second ECG data. The method includes selecting a first phase and displaying, at the same time, a first one of the B-mode images, the first ultrasound image, and a marker. The first one of the B-mode images includes the ROI at the first phase. The marker is positioned at a first position with respect to the first ultrasound image and the first position indicates the first phase.

In an embodiment, a method of ultrasound imaging includes acquiring first ultrasound data of a region-of-interest (ROI) and associated first ECG data. The first ultrasound data includes an M-mode image or a spectral Doppler image. The method includes acquiring second ultrasound data of the ROI and associated second ECG data, the second ultrasound data comprising B-mode data. The method includes adjusting at least one of the first ultrasound data and the second ultrasound data to compensate for differences in heart cycle length between the first ultrasound data and the second ultrasound data. The method includes generating a first ultrasound image of the ROI from the first ultrasound data after adjusting at least one of the first ultrasound data and the second ultrasound data. The first image includes an M-mode image or a spectral Doppler image. The method includes generating a cine loop of B-mode images from the second ultrasound data after adjusting at least one of the first ultrasound data and the second ultrasound data. The method includes selecting a first phase and displaying a first one of the B-mode images in response to said selecting the first phase. The first one of the B-mode images including the ROI at the first phase. The method includes displaying both the first ultrasound image and a marker at the same time as the first one of the B-mode images in response to selecting the first phase. The marker is positioned to indicate the first phase with respect to the first ultrasound image.

In another embodiment, an ultrasound imaging system includes a display device, a user interface device, and a processor in electronic communication with the user interface device, and the display device. The processor is configured to receive a first ultrasound image of a region-of-interest (ROI) and associated first ECG data. The first ultrasound image includes an M-mode image or a spectral Doppler image. The processor is configured to receive a cine loop of B-mode images acquired from the ROI and associated second ECG data. The processor is configured to receive a command to select a phase from the user interface device. The processor is configured to display, at the same time, a first one of the B-mode images, the first ultrasound image, and a marker on the display device. The first one of the B-mode images includes the ROI at the first phase. The marker is positioned at a first position with respect to the first ultrasound image and the first position indicates the first phase.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram of an ultrasound imaging system in accordance with an embodiment;

FIG. 2 is a flow chart of a method in accordance with an embodiment;

FIG. 3 is a schematic representation of a screen shot in accordance with an embodiment; and

FIG. 4 is a schematic representation of a screen shot in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

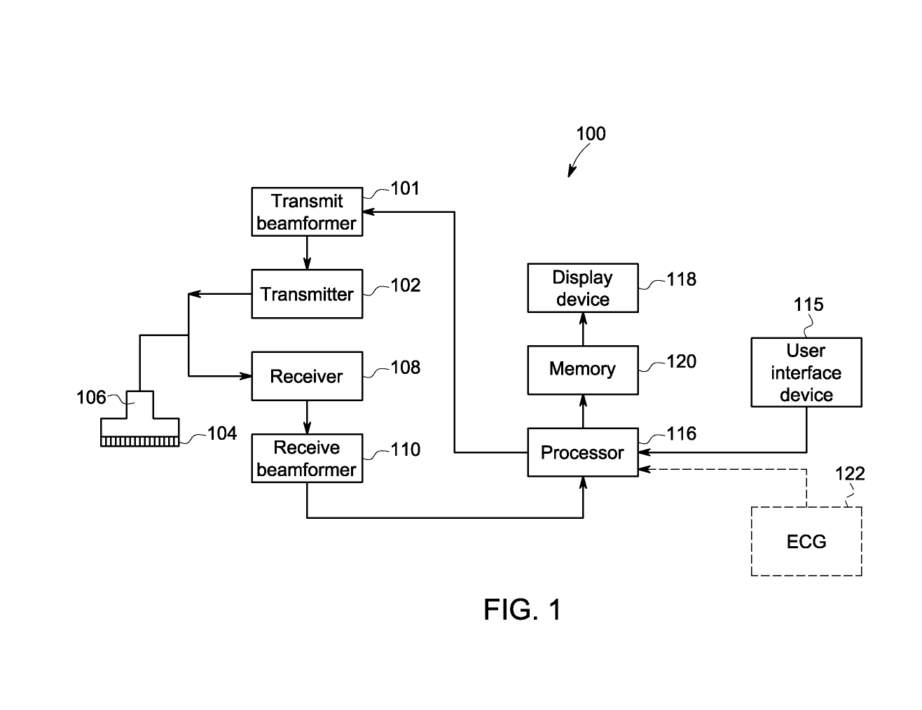

FIG. 1 is a schematic diagram of an ultrasound imaging system 100 in accordance with an embodiment. The ultrasound imaging system 100 includes a transmit beamformer 101 and a transmitter 102 that drive elements 104 within a probe 106 to emit pulsed ultrasonic signals into a body (not shown). The probe 106 may be an 2D array probe according to an embodiment. The pulsed ultrasonic signals are back-scattered from structures in the body, like blood cells or muscular tissue, to produce echoes that return to the elements 104. The echoes are converted into electrical signals, or ultrasound data, by the elements 104 and the electrical signals are received by a receiver 108. The electrical signals representing the received echoes are passed through a receive beamformer 110 that outputs ultrasound data. According to some embodiments, the probe 106 may contain electronic circuitry to do all or part of the transmit and/or the receive beamforming. For example, all or part of the transmit beamformer 101, the transmitter 102, the receiver 108 and the receive beamformer 110 may be situated within the probe 106. The terms “scan” or “scanning” may also be used in this disclosure to refer to acquiring data through the process of transmitting and receiving ultrasonic signals. The terms “data” or “ultrasound data” may be used in this disclosure to refer to either one or more datasets acquired with an ultrasound imaging system. A user interface device 115 may be used to control operation of the ultrasound imaging system 100, including, to control the input of patient data, to change a scanning or display parameter, and the like.

The ultrasound imaging system 100 also includes a processor 116 to control the transmit beamformer 101, the transmitter 102, the receiver 108 and the receive beamformer 110. The processor 116 is in electronic communication with the probe 106. The processor 116 may control the probe 106 to acquire data. The processor 116 controls which of the elements 104 are active and the shape of a beam emitted from the probe 106. The processor 116 is also in electronic communication with a display device 118, and the processor 116 may process the data into images for display on the display device 118. For purposes of this disclosure, the term “electronic communication” may be defined to include both wired and wireless connections. The processor 116 may include a central processor (CPU) according to an embodiment. According to other embodiments, the processor 116 may include other electronic components capable of carrying out processing functions, such as a digital signal processor, a field-programmable gate array (FPGA) or a graphic board. According to other embodiments, the processor 116 may include multiple electronic components capable of carrying out processing functions. For example, the processor 116 may include two or more electronic components selected from a list of electronic components including: a central processor, a digital signal processor, a field-programmable gate array, and a graphic board. According to another embodiment, the processor 116 may also include a complex demodulator (not shown) that demodulates the RF data and generates raw data. In another embodiment the demodulation can be carried out earlier in the processing chain. The processor 116 may be adapted to perform one or more processing operations according to a plurality of selectable ultrasound modalities on the data. The data may be processed in real-time during a scanning session as the echo signals are received. For the purposes of this disclosure, the term “real-time” is defined to include a procedure that is performed without any intentional delay. The data may be stored temporarily in a buffer (not shown) during a scanning session and processed in less than real-time in a live or off-line operation. Other embodiments of the invention may include multiple processors to handle the processing tasks. For example, a first processor may be utilized to demodulate and decimate the RF signal while a second processor may be used to further process the data prior to displaying an image. It should be appreciated that other embodiments may use a different arrangement of processors.

The ultrasound imaging system 100 may continuously acquire data at a volume-rate of, for example, 10 Hz to 30 Hz. Images generated from the data may be refreshed at a similar volume-rate. Other embodiments may acquire and display data at different rates. For example, some embodiments may acquire data at a volume-rate of less than 10 Hz or greater than 30 Hz depending on the size of the volume and the intended application. A memory 120 is included for storing processed frames or images of acquired data. In an exemplary embodiment, the memory 120 is of sufficient capacity to store at least several seconds worth of frames of ultrasound data. The frames of data are stored in a manner to facilitate retrieval thereof according to its order or time of acquisition. The memory 120 may comprise any known data storage medium. An ECG 122 may optionally be connected to the processor 116. The ECG 122 shown in FIG. 1 is not part of the ultrasound imaging system 100, but according to other embodiments, the ECG 122 may be an integral component of the ultrasound imaging system 100.

Optionally, embodiments of the present invention may be implemented utilizing contrast agents. Contrast imaging generates enhanced images of anatomical structures and blood flow in a body when using ultrasound contrast agents including microbubbles. After acquiring data while using a contrast agent, the image analysis includes separating harmonic and linear components, enhancing the harmonic component and generating an ultrasound image by utilizing the enhanced harmonic component. Separation of harmonic components from the received signals is performed using suitable filters. The use of contrast agents for ultrasound imaging is well-known by those skilled in the art and will therefore not be described in further detail.

In various embodiments of the present invention, data may be processed by other or different mode-related modules by the processor 116 (e.g., B-mode, Color Doppler, M-mode, Color M-mode, spectral Doppler, Elastography, TVI, strain, strain rate, and the like) to form 2D or 3D data. For example, one or more modules may generate B-mode, color Doppler, M-mode, color M-mode, spectral Doppler, Elastography, TVI, strain, strain rate and combinations thereof, and the like. The image beams and/or frames are stored and timing information indicating a time at which the data was acquired in memory may be recorded. The modules may include, for example, a scan conversion module to perform scan conversion operations to convert the image frames from coordinates beam space to display space coordinates. A video processor module may be provided that reads the image frames from a memory and displays the image frames in real time while a procedure is being carried out on a patient. A video processor module may store the image frames in an image memory, from which the images are read and displayed.

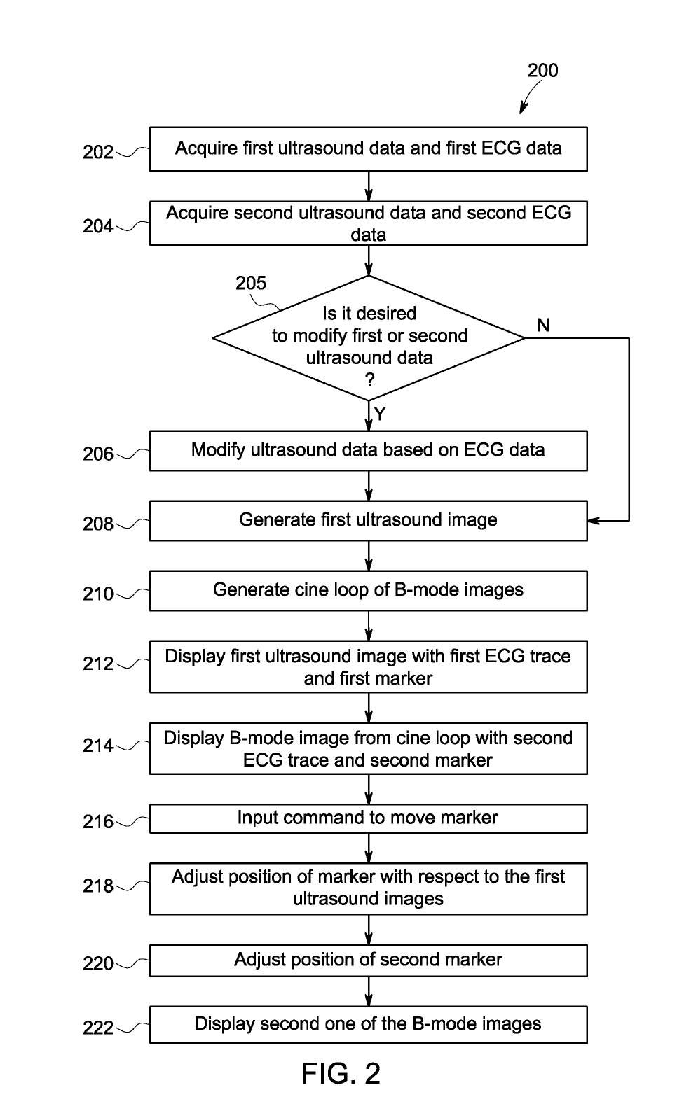

FIG. 2 is a flow chart of a method in accordance with an exemplary embodiment. The individual blocks of the flow chart represent steps that may be performed in accordance with the method 200. Additional embodiments may perform the steps shown in a different sequence and/or additional embodiments may include additional steps not shown in FIG. 2. The technical effect of the method 200 is the adjustment of the position of a marker with respect to both an ECG trace and a first ultrasound image and the display of a B-mode image in response to inputting a command. The method 200 will be described according to an exemplary embodiment where the method 200 is implemented by the processor 116 of the ultrasound imaging system 100 of FIG. 1. Additionally, the method 200 will be described according to an embodiment where the first image is a spectral Doppler image.

Referring to FIGS. 1 and 2, at step 202 the processor 116 acquires first ultrasound data from the ROI. For example, the processor 116 may control the transmit beamformer 101, the transmitter 102, the probe 106, the receiver 108 and the receive beamformer 110 to acquire first ultrasound data from within a region-of-interest, which will be referred to hereinafter as an ROI. According to an embodiment, a user may be able to selectively control the size and positioning of the ROI before step 202 is initiated. According to an exemplary embodiment, the first ultrasound data may be spectral Doppler data. According to other embodiments, the first ultrasound data may include M-mode data. Spectral Doppler data may be used to show velocities of moving tissue or fluids, such as blood. Spectral Doppler is used to detect motion in a tissue or fluid by transmitting one or more ultrasound pulses and detecting the frequency shift present in the received ultrasound signals. Spectral Doppler data may be displayed as a spectrum of flow velocities over a period of time. M-mode involves repeatedly acquiring a line or ultrasound data over a period of time. The M-mode data may then be displayed by simultaneously displaying data representing the line at different times. Any displacement of tissue present at the location of the line will be evident in the display of the M-mode data. Spectral Doppler and M-mode are both well-known imaging techniques and, therefore, will not be described in additional detail. It should be appreciated by those skilled in the art, that either the Spectral Doppler data or the M-mode data may be acquired from only a portion of the ROI, since both types of data are typically acquired from a small region.

Still referring to step 202, first ECG data is acquired during the process of acquiring the first ultrasound data. According to an embodiment, the ECG 122, which is connected to the ultrasound imaging system 100, may be used to acquire the first ECG data. A plurality of electrical leads may be connected to the patient in order to acquire the first ECG data.

Next, at step 204, the processor 116 acquires second ultrasound data and associated second ECG data. For example, the processor 116 may control the transmit beamformer 101, the transmitter 102, the probe 106, the receiver 108 and the receive beamformer 110 to acquire second ultrasound data of the same ROI used when acquiring the first ultrasound data at step 202. According to an exemplary embodiment, the second ultrasound data may include B-mode data. B-mode, or brightness mode, data may include brightness data for all of the ROI. The second ultrasound data includes a plurality of B-mode images, or frames, acquired over a period of time. Second ECG data is acquired during the process of acquiring the second ultrasound data by the ECG 122 according to an embodiment. According to another embodiment, instead of acquiring the first and second ultrasound data, the processor 116 may receive the first ultrasound data and the second ultrasound data from a memory or storage device, such as a picture archiving and communication system (PACS).

At step 205, the processor 116 determines if it is desired to modify the first or second ultrasound data due to a variation between the heart cycle length of the first ultrasound data and the heart cycle length of the second ultrasound data. The processor 116 may, for instance, compare the heart cycle length of the first ultrasound data with the heart cycle length of the second ultrasound data. For purposes of this disclosure the heart cycle length of the first ultrasound data is defined to include the heart cycle length that was present during the acquisition of the first ultrasound data, and the heart cycle length of the second ultrasound data is defined to include the heart cycle length that was present during the acquisition of the second ultrasound data. If the difference in heart cycle length is within a threshold, then the method 200 advances to step 208. However, if the difference in heart cycle length exceeds a threshold, then the method advances from step 205 to step 206.

At step 206, the processor 116 modifies either the first ultrasound data or the second ultrasound data based on the first and second ECG data. According to other embodiments, the processor 116 may modify both the first ultrasound data and the second ultrasound data at step 206. According to an embodiment, the first ultrasound data may be modified to match the heart cycle length of the second ultrasound data. The first ultrasound data may include spectral Doppler data or M-mode data. Spectral Doppler data may be presented as a spectral Doppler image that includes data for multiple cardiac cycles. M-mode data may be presented as an M-mode image which may likewise include data for multiple cardiac cycles. However, according to an exemplary embodiment, it may be desirable to have equivalent heart cycle lengths between the first ultrasound data and the second ultrasound data. Therefore, it may be necessary to perform a compression or a stretching of the first ultrasound data. Using the ECG data as a guide, since the ECG data is indexed to the patient's cardiac cycle, the first ultrasound data may be adjusted to match the heart cycle length of the second ultrasound data. According to other embodiments, the second ultrasound data may be adjusted to match the heart cycle length of the first ultrasound data. The process may be slightly different because the second ultrasound data comprises B-mode data, acquired over a period of time. It may be necessary to modify the second ultrasound data by correlating portions of the second ultrasound data with particular cardiac phases. The relative spacing of the images in the cine loop of B-mode images may for example be adjusted to match the heart cycle length of the first ultrasound data. For example, frames of data in the second ultrasound data may each be correlated to a specific cardiac phase based on the ECG data. According to other embodiments, both the first ultrasound data and the second ultrasound data may be modified by the processor 116 based on the ECG data. For example, adjustments may be applied to both the first ultrasound data and the second ultrasound data in order generate two datasets with a common heart rate or heart cycle length. Additionally, according to other embodiments, either the first ultrasound data or the second ultrasound data may be modified through a combination of both stretching and compressing.

Still referring to both FIGS. 1 and 2, next, at step 208, the processor 116 generates a first ultrasound image from the first ultrasound data. According to an exemplary embodiment, the first ultrasound data may comprise spectral Doppler data and the processor 116 may generate a spectral Doppler image at step 208. According to other embodiments, the first ultrasound image generated at step 208 may include a M-mode image. According to another embodiment, the processor 116 may receive the first image from a memory device such as a picture archiving and communication device (PACS).

At step 210, the processor 116 generates a cine loop of B-mode images. According to an embodiment, the processor 116 may generate the cine loop of B-mode images from the second ultrasound data. The cine loop may comprise a plurality of B-mode images according to an exemplary embodiment. Each of the plurality of B-mode images may have been acquired at a different time. Collectively, the cine loop of B-mode images shows the ROI at a plurality of different phases through one or more cardiac cycles. As described above, if the heart rates were different enough between the acquisition of the first ultrasound data and the acquisition of the second ultrasound data, adjustments are applied to at least one of the first ultrasound data and the second ultrasound data prior to either step 208 or step 210. As a result, the first ultrasound image generated from the first ultrasound data and the cine loop of B-mode images generated from the second ultrasound data both share a common heart cycle length. According to other embodiments, steps 202, 204, 205, and 206 of the method 200 may not be performed. For example, the processor may be located in a remote workstation and the first ultrasound image of the ROI and the cine loop of B-mode images may be received from either a separate ultrasound imaging system or from memory, such as from a picture archiving and communication system (PACS) or other types of memory devices.

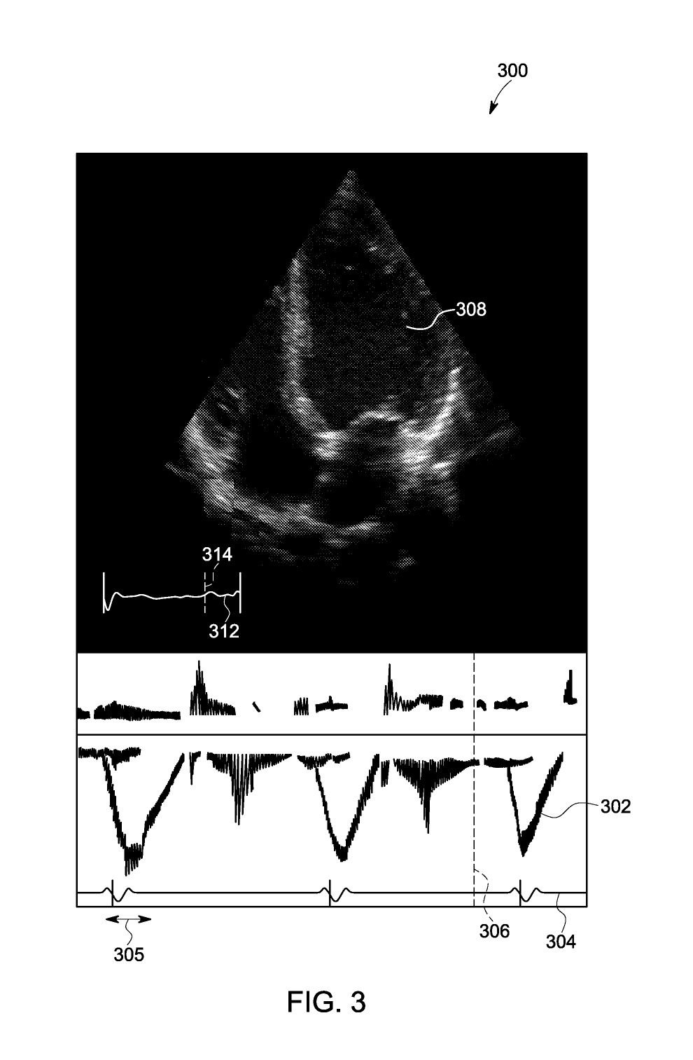

FIG. 3 is a schematic representation of a configuration of a screenshot 300 in accordance with an exemplary embodiment. The screenshot 300 may be presented on a display device such as the display device 118. Referring now to FIGS. 1, 2, and 3, at step 212 the processor 116 displays the first ultrasound image 302 on the display device 118. The first ultrasound image 302 shown in FIG. 3 is a spectral Doppler image in accordance with an embodiment. The processor 116 also displays a first ECG trace 304 that is aligned with the first ultrasound image 302. Both the first ultrasound image 302 and the first ECG trace 304 are aligned by phase in a horizontal direction 305. In other words, the cardiac phase represented in both the first ultrasound image 302 and the first ECG trace 304 are the same at any given horizontal position. A marker 306 is also positioned with respect to the ECG trace 304 and the first ultrasound image 302. The first marker 306 is shown as a dotted line. Other embodiments may user a different type of graphical indicator as a marker. For example, other embodiments may have a marker displayed as a solid line, a translucent solid line, an arrow, a highlighted region, or any other graphical indicator that denotes a specific portion of the cardiac cycle with respect to the first ECG trace 304 or with respect to the first ultrasound image 302.

FIG. 3 also includes a B-mode image 308 that is a portion of a cine loop. According to an embodiment, the B-mode image 308 depicts an ROI. FIG. 3 also includes a second ECG trace 312 and a second marker 314. The second marker 314 is a dashed line similar to the first marker 306 according to an embodiment. However, according to other embodiments, the second marker may be a different type of graphical indicator including any of the following non-limiting examples: a solid line, a translucent solid line, an arrow, or a highlighted region.

As was previously mentioned, the first ultrasound image 302 is a spectral Doppler image according to an exemplary embodiment, but the first ultrasound image may be an M-mode image according to other embodiments. At step 214, the processor 116 controls the display of a first one of the B-mode images 308. As described previously, the cine loop of B-mode images includes a plurality of B-mode images, each acquired at a different time. According to an embodiment, only one B-mode image from the cine loop will be displayed at a time. The B-mode image will be displayed as a static image rather than automatically displaying multiple images from the loop in sequence. For purposes of this disclosure, the term “B-mode image” will be defined to include any one of the plurality of B-mode images in the cine loop. Additionally, the term “displayed B-mode image” may be used to distinguish between the B-mode image from the cine loop that is currently being displayed and all the other B-mode images in the cine loop. The first one of the B-mode images 308 may be a B-mode image of the ROI. According to an exemplary embodiment, the processor 116 may also control the display of the second ECG trace 312 and the second marker 314. The first ultrasound image 302, the first ECG trace 304, the first marker 306, the B-mode image 308, the second ECG trace 312, and the second marker 314 are all displayed on the display device 118 at the same time.

Next, at step 216, the user inputs a command through the user interface device 115 in order to move the marker 306 from a first location to a second location. The cine loop of B-mode images, the position of the first marker 306 with respect to the first ultrasound image 302 and the first ECG trace 304, and the position of the second marker 314 with respect to the second ECG trace 312 are all synchronized based on phase according to an embodiment. That is, the phase of the displayed B-mode image, such as the B-mode image 308, is the same as the phase indicated by the position of the first marker 306 with respect to the first ultrasound image 302 and the first ECG trace 304 and the phase indicated by the position of the second marker 314 with respect to the second ECG trace 312. Therefore, when the clinician inputs the command at step 216, several things happen in a synchronized manner: the position of the first marker 306 is moved with respect to the first ultrasound image 302 and the first ECG trace 304; the position of the second marker 314 is moved with respect to the second ECG trace 312; and the first one of the B-mode images 308 is replaced with a second one of the B-mode images (not shown), the second one of the B-mode images shows the ROI at the phase indicated by the positions of the first marker 306 and the second marker 314. For example, the user may input a command through the user interface device 115 in any manner of ways including the following non-limiting list: moving a trackball left, right, forward, backward, moving the trackball in any other pattern, moving a mouse left, right, forward, backward, moving the mouse in any other pattern, using an arrow key, or adjusting a rotary knob. According to an embodiment, the position of the first marker 306, the position of the second marker 314, and the displayed B-mode image may be adjusted in real-time while the clinician inputs commands through the user interface device.

According to an embodiment, inputting the command at step 216 results in the generally simultaneous replacement of the first one of the B-mode images 308 with a second one of the B-mode images (not shown), the repositioning of the first marker 306, and the repositioning of the second marker 314. This way, the phase indicated by the first marker 306 and the phase of the displayed B-mode image are the same. Referring to the exemplary method 200, if the clinician selects a second phase at step 216 that is different than the first phase, at step 218, the processor 116 adjusts the position of the first marker 306 to a second position with respect to the first ECG trace 304 and the first ultrasound image 302. The second position (not shown) of the first marker 306 indicates the second phase with respect to the first ECG trace 304 and the first ultrasound image 302. Likewise, at step 220, the processor 116 adjusts the position of the second marker 314 to an updated position. The updated position indicates the second phase with respect to the second ECG trace 312. At step 222, the processor 116 replaces the first one of the B-mode images 308 with the second one of the B-mode images from the cine loop. The second one of the B-mode images from the cine loop represents the ROI at the second phase and corresponds with the phase indicated by the updated position of the first marker 306 and the second marker 314 with respect to the first ECG trace 304 and the second ECG trace 312 respectively. The second one of the B-mode images represents the anatomy in the ROI at the second phase. According to an embodiment, step 218, step 220, and step 222 of the method may be performed by the processor 116 in real-time in response to the inputting of the command at step 216. Step 218, step 220, and step 222 may be performed in a different order according other embodiments. According to an exemplary embodiment, step 218, step 220, and step 222 are performed at close to the same time, such as within 0.5 seconds from the inputting of the command at step 216, so that the marker 306, the second marker 314, and the B-mode image 308 appear to be adjusted in a substantially simultaneous manner in response to the single input from step 216. While the processing steps do not need to be performed in parallel, from a clinician's perspective, the movement of the first marker 306, the movement of the second marker 314, and the replacement of the first B-mode image 308 with a second B-mode image may appear to happen in a generally simultaneous manner in response to inputting a command to move the marker or select a different phase.

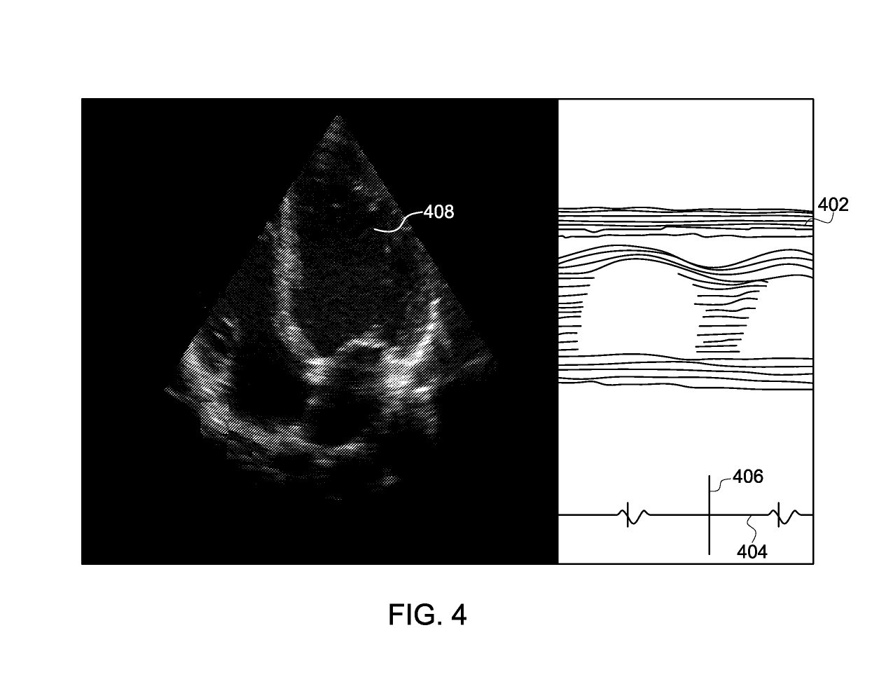

FIG. 4 is a schematic representation of a screen shot 400 in accordance with an embodiment. The screen shot 400 includes a first ultrasound image 402, an ECG trace 404, and a marker 406. The first ultrasound image 402 is an M-mode image of a mitral valve according to an embodiment. The screen shot 400 also includes a first B-mode image 408. The marker 406 is a solid line in accordance with an embodiment. The first B-mode image 408 includes the ROI at a first phase. The ECG trace 404 is aligned with the first ultrasound image 402 and the position of the marker 406 with respect to the ECG trace 404 and the first ultrasound image 402 indicates the phase of the first B-mode image 408. In accordance with an embodiment, there is not a second ECG trace or second marker associated with the first B-mode image 408 of the cine loop. However, since the cine loop, which includes a plurality of B-mode images, and the position of the marker 406 are both synchronized based on phase, the clinician may still easily discern the phase shown in the displayed B-mode image by referring to the position of the marker 406 with respect to the ECG trace 404 and the first ultrasound image 402. In accordance with an embodiment, it is anticipated that a clinician may control the phase of the B-mode image and the position of the marker 406 based on a single control input. The cine loop of B-mode images and the position of the marker 406 are both linked so the phase of the displayed B-mode image is the same as the phase indicated by the position of the marker with respect to the ECG trace 404 and the first ultrasound image 402.

Referring back to FIGS. 1, 2, and 3, according to an exemplary embodiment, the cine loop may be of a portion of the patient's heart and the first ultrasound image 302 may be a spectral Doppler image representing blood flow through an artery connected to the anatomy depicted in the cine loop. By implementing the method 200, the clinician is able to easily scan the spectral Doppler image (i.e. the first ultrasound image 302) in order to clearly identify a particular phase of the cardiac cycle. For example, the clinician may clearly identify a time in the cardiac cycle where blood flow either first ceases, representing a valve closure, or the time in the cardiac cycle where blood flow is first initiated, representing a valve opening. According to an embodiment, the clinician may control the position of the marker 306, and hence the phase, with a trackball or other user interface device. By scrolling the trackball, for example, the clinician may select a particular phase or quickly scan through many different phases. As described above, the position of the marker 306, the position of the second marker 314, and the cine loop of B-mode images are all adjusted in a simultaneous manner based on phase. This makes it particularly helpful when scanning through a plurality of different phases in order to identify one or more desired phases. For example, according to an embodiment, the position of the marker 306, the second marker 314, and the B-mode image may all be adjusted in a generally simultaneous manner in order to reflect the real-time phase selected by the clinician. As the clinician adjusts the user interface device 115, such as the trackball, the phase of the displayed B-mode image is the same as the phase indicated by the position of the first marker 306 and the position of the second marker 314 with respect to the first ECG trace 304/first ultrasound image 302 and the second ECG trace 312 respectively.

The method 200 is advantageous because the processor 116 automatically provides the necessary adjustments to accommodate variations in patient heart rate occurring between the acquisition of the first ultrasound data and the acquisition of the second ultrasound data. This allows the clinician to confidently use the first ultrasound image 302, whether it is a spectral Doppler image or an M-mode image, to positively identify a desired cardiac phase. Additionally, the method 200 provides an improved workflow for identifying a specific B-mode image in a cine loop to be used for further diagnostic or quantitative purposes. By both automatically adjusting for any heart rate discrepancies and linking a spectral Doppler or M-mode image to a cine loop of B-mode images based on phase, clinicians have a more robust technique for identifying a desired phase.

The method 200 additionally save clinicians time. Since the position of the first marker 306 and the cine loop of B-mode images are linked based on phase, the clinician can rapidly scroll through cardiac phases until the B-mode image of the proper phase has been identified. Then, the clinician may slowly advance image-by-image through the cine loop until the desired B-mode image is obtained. While not required by the method 200, it is anticipated that the clinician may alternate focus between the displayed B-mode image and the spectral Doppler image as they approach the desired phase. The clinician may therefore easily check to insure the displayed B-mode image looks correct and diagnostically useful based on their experience. If there is a problem with the displayed B-mode image, the clinician may either try adjusting by a few frames in either direction or else determine that the ultrasound data is not sufficient and needs to be reacquired. Having an M-mode image or a spectral Doppler image linked to a cine loop of B-mode images based on phase saves the clinician time in relatively standard cases and enables a much more accurate diagnosis or quantification in atypical cases.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method of displaying ultrasound image information using a processor, comprising:
receiving a first ultrasound image of a region-of-interest (ROI) and associated first ECG data, the first ultrasound image comprising an M-mode image or a spectral Doppler image;
receiving a cine loop of B-mode images acquired from the ROI and associated second ECG data;
selecting a first phase; and
displaying, at the same time, a first one of the B-mode images, the first ultrasound image and a marker, wherein the first one of the B-mode images comprises the ROI at the first phase, and wherein the marker is positioned at a first position with respect to the first ultrasound image, the first position indicating the first phase.

2. The method of claim 1, further comprising displaying an ECG trace at the same time as the first ultrasound image, the first one of the B-mode images and the marker.

3. The method of claim 2, wherein the marker is superimposed on one or both of the first ultrasound image and the ECG trace.

4. The method of claim 2, further comprising displaying a second ECG trace and a second marker at the same time as the ECG trace, the marker, the first ultrasound image, and the first one of the B-mode images, wherein the second ECG trace represents the second ECG data, and wherein the second marker is positioned to indicate the first phase with respect to the second ECG trace.

5. The method of claim 1, wherein the marker comprises a line or a dashed line.

6. The method of claim 1, wherein the marker is superimposed on both the ECG trace and at least a portion of the first ultrasound image.

7. The method of claim 1, further comprising:
inputting a command to move the marker;
moving the marker to a second location with respect to the first ultrasound image in response to said inputting the command, the second location corresponding to a second phase, and
displaying a second one of the B-mode images in place of the first one of the B-mode images in response to said inputting the command to move the marker, the second one of the B-mode images corresponding to the second phase.

8. The method of claim 7, wherein said inputting the command comprises inputting a command through a trackball or a mouse.

9. The method of claim 8, wherein said inputting the command comprises manipulating the trackball or mouse to the left or right to move the marker.

10. The method of claim 8, wherein said inputting the command comprises manipulating the trackball or mouse forward or backward to move the marker.

11. The method of claim 7, wherein said moving the marker to the second location and said displaying the second one of the plurality of B-mode images in place of the first one of the plurality of B-mode images are performed in synchronization in response to said inputting the command to move the marker.

12. A method of ultrasound imaging comprising:
acquiring first ultrasound data of a region-of-interest (ROI) and associated first ECG data, the first ultrasound data comprising an M-mode image or a spectral Doppler image;
acquiring second ultrasound data of the ROI and associated second ECG data, the second ultrasound data comprising B-mode data;
adjusting at least one of the first ultrasound data and the second ultrasound data to compensate for differences in heart cycle length between the first ultrasound data and the second ultrasound data;
generating a first ultrasound image of the ROI from the first ultrasound data after said adjusting at least one of the first ultrasound data and the second ultrasound data, the first image comprising an M-mode image or a spectral Doppler image;
generating a cine loop of B-mode images from the second ultrasound data after said adjusting at least one of the first ultrasound data and the second ultrasound data;
selecting a first phase;
displaying a first one of the B-mode images in response to said selecting the first phase, the first one of the B-mode images comprising the ROI at the first phase; and
displaying both the first ultrasound image and a marker at the same time as the first one of the B-mode images in response to said selecting the first phase, wherein the marker is positioned to indicate the first phase with respect to the first ultrasound image.

13. The method of claim 12, further comprising displaying a first ECG trace based on the first ECG data at the same time as the first of the B-mode images, the first ultrasound image, and the marker.

14. The method of claim 13, wherein the marker is positioned to indicate the first phase with respect to the first ECG trace as well as the first ultrasound image.

15. A ultrasound imaging system comprising:
a display device
a user interface device; and
a processor in electronic communication with the user interface device and the display device, wherein the processor is configured to:
receive a first ultrasound image of a region-of-interest (ROI) and associated first ECG data, the first ultrasound image comprising an M-mode image or a spectral Doppler image;
receive a cine loop of B-mode images acquired from the ROI and associated second ECG data;
receive a command to select a phase from the user interface device; and
display, at the same time, a first one of the B-mode images, the first ultrasound image, and a marker on the display device, wherein the first one of the B-mode images comprises the ROI at the first phase, and wherein the marker is positioned at a first position with respect to the first ultrasound image, the first position indicating the first phase.

16. The ultrasound imaging system of claim 15, wherein the user interface device comprises a trackball or a mouse.

17. The ultrasound imaging system of claim 15, wherein the processor is further configured to control the probe to acquire first ultrasound data and second ultrasound data from the region-of-interest.

18. The ultrasound imaging system of claim 15, wherein the processor is further configured to both move the marker from the first position to a second position and replace the first one of the B-mode images with a second one of the B-mode images in response to the inputting of a command through the user interface device, wherein the second position of the marker indicates a second phase with respect to the first ultrasound image and the second one of the B-mode images comprises the ROI at the second phase.

19. The ultrasound imaging system of claim 15, wherein the processor is configured to display an ECG trace based on the first ECG data at the same time as the first ultrasound image, the first one of the B-mode images and the marker.

20. The ultrasound imaging system of claim 19, wherein the marker comprises a line or a dotted line superimposed on at least one of the first ultrasound image and the ECG trace.
